(19) United States
(12) Patent Application Publication
(10) Pub. No.: US 2012/0276926 A1
(43) Pub. Date: Nov. 1, 2012

(54) Location Fidelity Adjustment Based on Mobile Subscriber Privacy Profile

(76) Inventor: Lance Douglas Pitt, Kent, WA (US)

(21) Appl. No.: 13/528,102

(22) Filed: Jun. 20, 2012

Related U.S. Application Data
(63) Continuation-in-part of application No. 13/403,291, filed on Feb. 23, 2012.
Application No. 13/403,291 is a continuation of application No. 10/265,390, filed on Oct. 7, 2002, now Pat. No. 8,126,889.
(60) Provisional application No. 60/367,711, filed on Mar. 28, 2002.
(60) Provisional application No. 60/382,368, filed on May 23, 2002.

(51) Int. Cl. H04W 64/00

(52) U.S. Cl. 455/456.2

(57) ABSTRACT

Location based wireless technology dynamically adjusts the accuracy of location information provided to a requesting party based on an aggregation of a plurality of location modifiers, each adjusting the accuracy of the current location from a more accurate version to a less accurate version having reduced accuracy.

The present application is a continuation-in-part of U.S. application Ser. No. 13/403,291, which is a continuation of U.S. application Ser. No. 10/265,390, now U.S. Pat. No. 8,126,889, which claims priority from U.S. Appl. No. 60/367,711, filed Mar. 28, 2002, entitled “Mobile Subscriber Privacy Evaluation Using Solicited vs. Unsolicited Differentiation”; and from U.S. Appl. No. 60/382,368, filed May 23, 2002, entitled “Location Fidelity Adjustment Based on Mobile Subscriber Privacy Profile”, the entirety of all of which are expressly incorporated herein by reference.

### BACKGROUND OF THE INVENTION

1. Field of the Invention

This invention relates generally to wireless and long distance carriers, Internet service providers (ISPs), and information content delivery services/providers and long distance carriers. More particularly, it relates to location services for the wireless industry.

2. Background of Related Art

Location technology in a wireless world essentially is surveillance technology. When location technology is used to provide services other than emergency services it's necessary to allow the mobile subscriber to control to whom their location may be reported.

Currently, privacy solutions in a wireless carrier's network are based on the source of the information. For instance, one conventional solution provides a privacy profile evaluator wherein the wireless user may define the requesting sources to whom location information may be provided.

Other commercial privacy solutions either use a default “opt-out” technique (i.e., the subscriber's privacy info is disseminated unless explicitly denied to all requestors by the subscriber), or a default “opt-in” technique (i.e., the subscriber's privacy info is not disseminated unless explicitly allowed by the subscriber). Either option works well in some scenarios, but may become very cumbersome in other scenarios.

There is a need for a less cumbersome, more efficient and generally better privacy solution, particularly for location based applications.

### SUMMARY OF THE INVENTION

In accordance with the principles of the present invention, a method of adjusting current location information regarding a wireless device comprises receiving a location request for current location information regarding a particular wireless device. An accuracy of the current location information corresponding to the particular wireless device is adjusted based on an aggregation of a plurality of location modifiers, each of the plurality of location modifiers adjusting the accuracy of the current location from a more accurate version to a less accurate version having reduced accuracy. The less accurate current location information is transmitted as a response to the location request.

### BRIEF DESCRIPTION OF THE DRAWINGS

Features and advantages of the present invention will become apparent to those skilled in the art from the following description with reference to the drawings, in which:

FIG. 1 shows an exemplary location fidelity adjustment system installed in a wireless carrier's network, in accordance with the principles of the present invention.

FIG. 2 depicts various embodiments of a location determiner shown in FIG. 1.

FIG. 3 shows an exemplary subscriber fidelity setting table maintained for each wireless user supported in the fidelity database shown in FIG. 1.

FIG. 4 shows an exemplary process of allowing a subscriber to dynamically adjust their personal location information fidelity, in accordance with the principles of the present invention.

FIG. 5 shows an exemplary process of filtering requested location information in accordance with fidelity settings established for a particular subscriber, in accordance with the principles of the present invention.

### DETAILED DESCRIPTION OF ILLUSTRATIVE EMBODIMENTS

The present invention appreciates that evaluation of a mobile subscriber's privacy should not be just a black or white, yes or no answer based on the source requesting the privacy information, as in conventional systems. Rather, the present invention provides mobile subscribers with the opportunity to mediate the release of all or part of their privacy information (e.g., the accuracy of their location) based, e.g., on the time when the request for their privacy information (e.g., location) is received or even, in some cases, obscure all components of the mobile subscriber's real private information by providing syntactically correct but alternate information representing whatever location the mobile subscriber chooses to represent (i.e. spoofing). In addition, this feature may be augmented with the ability of the subscriber to adjust the amount or accuracy of their privacy information provided, based on the time when the request for their privacy information is received.

In accordance with the principles of the present invention, location based wireless services in a service provider's network are commissioned and intertwined with a privacy center to automatically provide a range of location information depending upon the subscriber's particular criteria (e.g., time of day or day of week).

The present invention utilizes location based wireless technology in a wireless network to dynamically automate the accuracy of location information provided to requesting parties based on external criteria, e.g., the time of day or the day of week.

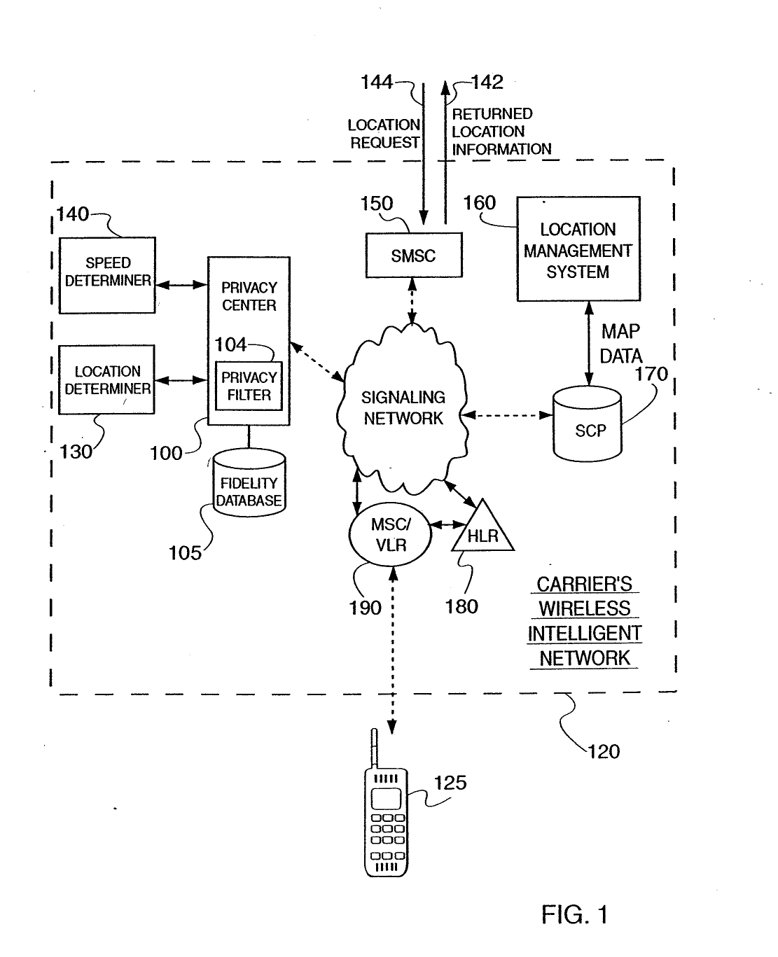

FIG. 1 shows a privacy center application 100 resident in a carrier's wireless intelligent network, in accordance with the principles of the present invention. The privacy center application 100 may be resident in any of many possible elements in the wireless intelligent network, e.g., in the SCP 170, in accordance with the principles of the present invention.

Upon receipt of a location request by a third party, the wireless network 120 communicates with a location management system 160 and a location determiner 130. A speed determiner 140 may optionally be included to provide rate of movement information regarding the subscriber 125.

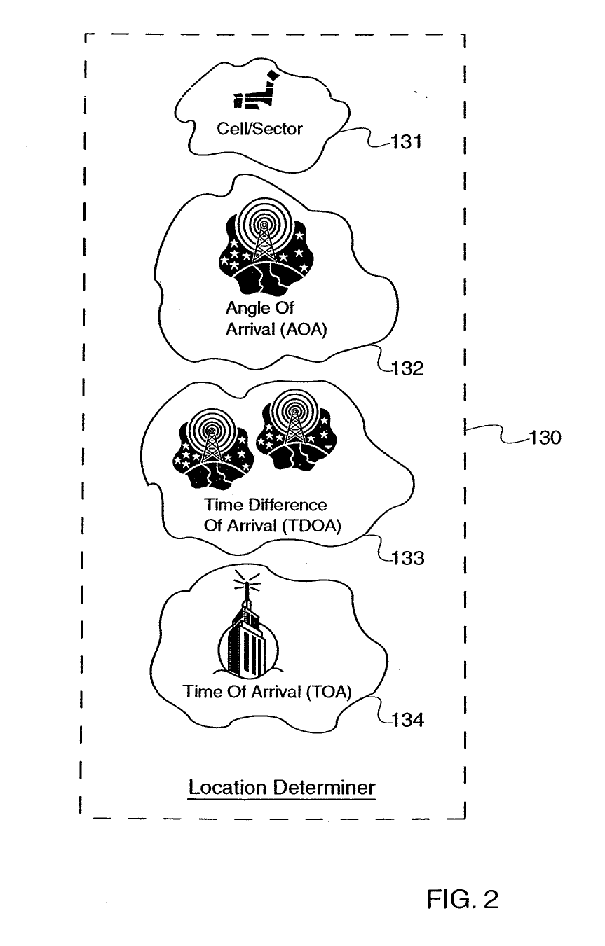

FIG. 2 depicts various embodiments of a location determiner 130 shown in FIG. 1.

In particular, as shown in FIG. 2, the location determiner 130 and location management system 160 perform the location management functions of determining subscriber location. Exemplary techniques implemented in the location determiner 130 may be, e.g., call/sector ID 131, angle of arrival (AOA) 132, time difference of arrival (TDOA) 130, time of arrival (TOA) 134, all of which are otherwise known in the art. The location determiner 130 may include any one or more of the exemplary location modules 131-134 shown in FIG. 2; it need not include all the modules 131-134 shown in FIG. 2. Moreover, these exemplary techniques are exemplary current methods of location determination. The present invention is separate from the particular mechanism used to determine location. Thus, any appropriate location determination mechanism may be used in accordance with the principles of the present invention.

Location information may be determined by a centrally located location determiner 130 (or by an individual wireless user 125 e.g., using a GPS device) and provided to the privacy center 100. Additionally, speed information may optionally be determined by the location management system of the wireless network 120, to augment the location information. For instance, the slower the speed of the subscriber, fewer location updates may be required, lessening the burden on the wireless intelligent network 120.

Returning back to FIG. 1, the wireless network 120 of the disclosed embodiment further includes a Short Message Service Center (SMSC) 150, Message Servicing Center (MSC) with Visitors Location Register (VLR) 190 and Home Location Register (HLR) 180.

The privacy center 100 in accordance with the principles of the present invention utilizes location information determined by a location determiner 130 to provide a proximate location of a wireless user 125, and then importantly adjusts that information based on customized criteria resident in a fidelity database 105 with respect to that particular wireless user 125. Typically, a wireless user's info will only be adjusted to be less accurate, but in some cases wireless users will be allowed to “spoof” their information such that the information is not just a less accurate depiction of reality but, rather, may be a very accurate depiction of non-reality; for instance, a traveling business person may not want to simply reduce the fidelity of reported location to “Zip Code” when the person is in the Dallas-Fort Worth airport (DFW) because vendor sales persons that know that the business person lives and works in Los Angeles, Calif., can make an educated guess that when the business person's reported location is ‘75261’ that there's a quite good chance that the business person is now or will soon be in the Dallas-Fort Worth airport. In cases such as this the business person may prefer to simply report locations (of varied and sundry accuracy) in and around Los Angeles, Calif.

The privacy center 100 may be installed on a dedicated computer system, or may be an application loaded on a computer having other responsibilities and tasks within the wireless network.

The fidelity database 105 contains a plurality of entries, each relating to a particular wireless user 125. For each wireless user, the fidelity of privacy information in general, and location information in particular, may be made less accurate or even spoofed during certain designated times of the day.

In accordance with the principles of the present invention, time and/or location sensitive “fidelity” adjustments to privacy information or even spoofed private information may be established by the subscriber, on a subscriber-by-subscriber basis. Moreover, the fidelity adjustments or spoofed information may be dynamically changed by the subscriber as their needs change.

“Fidelity” adjustment refers to the ability to filter the amount of private information that is provided to third party requesters, e.g., in a wireless network. “Spoofed” private information refers to the ability to represent said private information in manner not necessarily directly associated with current reality. In accordance with the principles of the present invention, upon receipt of a request for the location of a particular subscriber, the authorized level of disclosure of privacy information (e.g., location) for that particular wireless user 125 in a fidelity database is checked, and adjusted or spoofed as necessary, before providing a response to the location request. In response, the location request preferably includes only the authorized or spoofed portion of the privacy (e.g., location) information (e.g., only a state or a city).

For instance, in the given example of a third party request for the exact location of a particular subscriber, the privacy center 100 receives the request, filters out or spoofs certain privacy information based on the settings previously established by the subscriber using an appropriate privacy filter 104, and returns the requested location information based on the limitations/parameters previously established by the wireless user 125.

For instance, the particular time of receipt of the request for location and/or location of the wireless user 125 may be parameters which alter the amount of private information (e.g., location) or, potentially, alter the private information, itself, that is to be provided to the requesting third party.

The present invention is applicable in conjunction with other methods of providing privacy to wireless users. For instance, opt-out or opt-in systems may be in place to exclude (or include) certain third party requesters from receiving any privacy information from a particular wireless user 125.

After determining that a requestor is allowed to get any level of privacy information regarding a particular wireless user 125, the privacy center 100 checks the privacy preferences previously established by the particular wireless user 125 to determine whether to spoof the wireless users's location and then to what degree of accuracy to report the private information (i.e. location).

For additional information regarding privacy permission techniques and apparatus, please refer to U.S. Appl. No. 60/367,711, filed Mar. 28, 2002, entitled “Mobile Subscriber Privacy Evaluation Using Solicited vs. Unsolicited Differentiation”, the entirety of which is expressly incorporated herein by reference.

If a preference is applicable, then the privacy center 100 retrieves the required privacy information modifier and passes the same to the application from which the location information will be disseminated (e.g., to the location management system 160). If the wireless user's “found” or spoofed location is more accurate than allowed by the privacy evaluation determined by the privacy center 100 utilizing the wireless user's criteria stored in the fidelity database 105, then the accuracy of the location information to be reported must be reduced to the level previously specified by the wireless user 125. The change in the accuracy of the location information may be performed in the privacy center itself, or within the location management system 160 as instructed by the privacy center 100. Accuracy may be reduced using any otherwise conventional suitable technique, e.g., as is performed by the Global Positioning Satellite (GPS) system in times of war. For instance, instead of providing location information to within a 10 foot accuracy, location information may be provided to within a much larger accuracy, e.g., to within 300 feet by randomly moving the location within the desired window of accuracy.

If, on the other hand, the wireless user's “found” or spoofed location provided by the location determiner 130 is already less accurate than that allowed by the privacy evaluation of the wireless user's privacy criteria as retrieved from the fidelity database 105, then the relevant application (e.g., the location management system 160 or the privacy center 100 itself) may simply disseminate the “found” or spoofed location to the requesting party.

In the disclosed embodiment, if no preference is selected by the wireless user 125, then the accuracy of the disclosed privacy information preferably defaults to the most accurate setting (e.g., to the street).

Note that although in the present embodiment location is determined by a centrally located location determiner 130, the principles of the invention relate equally to a GPS or similar device in some or all mobile devices 125.

Voice recognition may be implemented in the carrier's wireless network 120 (e.g., accessible to the SCP 170) to simplify a user's input of relevant information, e.g., in setting privacy criteria in their relevant entry in the fidelity database 105.

The privacy center 100 maintains a list that is checked for the mobile subscriber's information every time information is to be disseminated. While in general the list is checked each time a location request is received, this need not correspond one to one with specific location requests. For instance, one form of location request is a “Periodic Location Request”. This type of request is established once, and then periodically attempts to report a subscriber's location. Thus, the list is checked every time information is to be disseminated.

The privacy center 100 also provides database tables with which customer carriers can initialize some aspects of a new subscriber's privacy profile. This capability is provided to allow customer carriers to configure the system to closely meet the needs of their customer base.

In both cases all the privacy database tables may initially be empty. This allows new wireless users to utilize location enabled services by calling the service (i.e. soliciting the service) without first having to log in to a web site and add the service provider to an “enable” list. This initial state also prevents the wireless user's information from being passed to anyone without their interaction beforehand. This empty initial state also means that all wireless users starts with no spoofing defined or enabled at all.

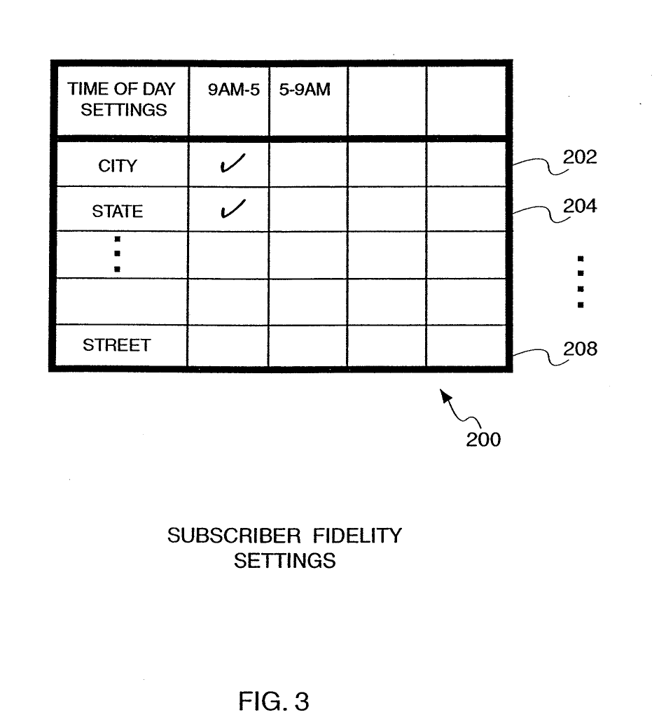

FIG. 3 shows an exemplary subscriber fidelity setting table 200 maintained for each wireless user 125 supported in the fidelity database 105 shown in FIG. 1.

In particular, as shown in FIG. 3, in one disclosed embodiment, a privacy solution in accordance with the principles of the present invention maintains an ordered list of “preferences” for each wireless user (e.g., mobile subscriber) based on given external criteria. For instance, the accuracy of provided location information may be altered or spoofed based on the particular time-of-day and/or day-of-week that the location request is received.

In accordance with the principles of the present invention, wireless users may define any of many privacy preferences, e.g., similar in nature to conventional email filters.

Importance may be placed on the ordering of preferences listed for any particular wireless user 125. For instance, the individual entries 202-208 for a particular wireless user 125 may be specifically ordered by the wireless user such that the preferences may be analyzed by the privacy center 100 in the same order. In the given embodiment, preference analysis stops once the first applicable preference is found, making the ordering of individual entries or preferences 202-208 important in such an embodiment.

In the given embodiment, every preference 202-208 in the fidelity settings table 200 can be made up of zero (0) to many constraints and one and only one modifier. Time-of-day and day-of-week are examples of preference constraints. Allowed Accuracy (i.e. street, city, zip code, state, country, NONE, or SPOOFED with representation of location to be reported) is an example of a preference modifier.

Any preference with no constraints may be considered “unconstrained” and thus will always be applicable.

Time-of-day and day-of-week constraints are preferably each entered as pairs of values with which ranges may be defined. Preferences with only time-of-day constraints will be applicable in that range of hours every day. Preferences with only day-of-week constraints will be applicable in that range of days every week. Preferences with both time-of-day and day-of-week constraints will be applicable in that range of hours during that range of days every week.

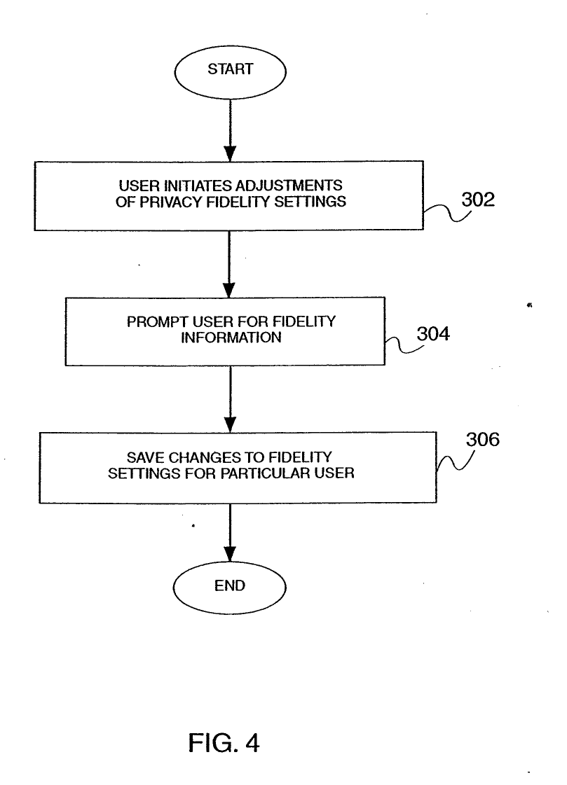

FIG. 4 shows an exemplary process of allowing a subscriber to dynamically adjust their personal location information fidelity, in accordance with the principles of the present invention.

In particular, as shown in step 302 of FIG. 4, a wireless user 125 initiates adjustment of their customizable privacy fidelity preferences 202-208 in the fidelity table 200 stored in the fidelity database 105 relating to them.

In step 304, the wireless user 125 may be prompted (e.g., audibly) for parameters and modifiers from a given menu of options.

In step 306, the selected parameters and modifiers are saved to the fidelity database 105 for use by the privacy center 100.

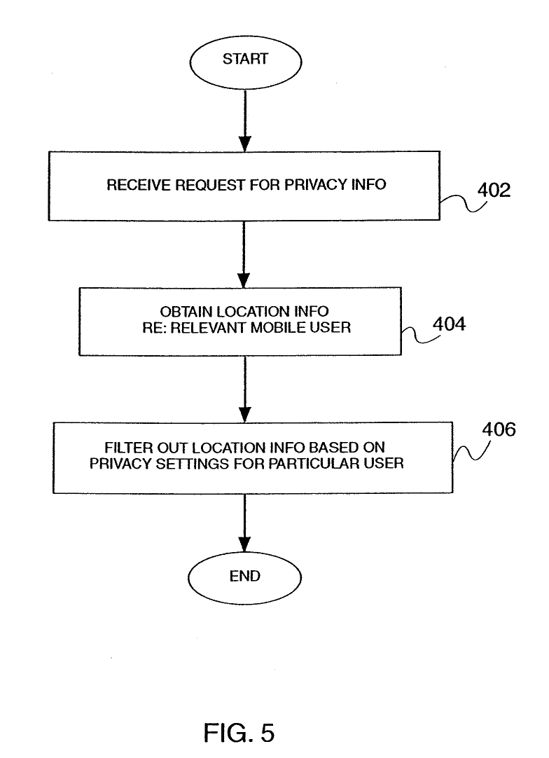

FIG. 5 shows an exemplary process of filtering requested location information in accordance with fidelity settings established for a particular subscriber, in accordance with the principles of the present invention.

In particular, as shown in step 402 of FIG. 5, the privacy center 100 receives word of a request for privacy information (e.g., location) of a wireless subscriber 125 within the wireless intelligent network 120.

In step 404, location information is obtained regarding a relevant wireless user 125 from the location determiner 130.

In step 406, a privacy filter function 104 in the privacy center 100 (or other system such as the location management system 160) either spoofs location information or filters out unauthorized location information based on privacy settings for the requested wireless user 125.

In the disclosed embodiments, location information is either spoofed or made less accurate by removing particular information such as the state, the city, the street, etc. at which the wireless user 125 currently exists, or sometimes even spoofed and then also made less accurate. However, the present invention relates equally to a mathematical alteration of the accuracy of location information. For instance, if location is not spoofed and the real location information is available to within 10 meters, but less accurate location information is to be provided to a particular requester, the location information may be randomly altered by a given amount (e.g., adding 100 to 1000 meters to the determined location), or may be provided only to within a given region.

In another embodiment of the invention, if a preference is applicable, then the privacy center 100 retrieves the required privacy information modifier and passes the same to the application from which the location information will be disseminated (e.g., to the location management system 160). If configured with “multiple-rule-aggregation” as its default mode of operation or if prompted within the privacy query itself with a “multiple-rule-aggregation” as a message parameter then the privacy center will look for any and all privacy information modifiers pertaining to the subscriber whose location information is to be disseminated. The privacy center always passes a “transactionID” value back to the service that initiated the query. The privacy center supports two (2) different mechanisms with which to pass all applicable privacy information modifiers back to the service that initiated the query:
1) The privacy center checks for the existence (i.e. determined by looking for non-zero values) of optional input parameters, including but not limited to, a modifier array reference and a maximum size count. If the privacy center finds both that the modifier array reference is non-zero and that the maximum size count is positive .AND. the total number of information modifiers is less than or equal to the maximum size count then the privacy center will copy all of the information modifiers into the referenced array, set the value of maximum size count to the number of modifiers, and return the data to the service that initiated the query. If the privacy center finds that the number of information modifiers exceeds the capacity of the referenced array then the privacy center will not copy any of the information modifiers into the referenced array and will set the value of the maximum size count to a negative value whose absolute value equals the number of information modifiers (i.e. −1*number-of-modifiers).

### OR

2) The privacy center provides a secondary query (i.e. alternate invocation entry point [a.k.a. function or procedure]) that accepts three (3) parameters: a transactionID parameter, an information modifier parameter, and an Index parameter. When the privacy center's secondary query is invoked the privacy center looks for the information modifiers saved as a result of the original, primary query and copies a saved information modifier into the information modifier parameter; the information modifier that is copied corresponds to one and only one information modifier saved as part of the set of information modifiers related to the transaction as isolated by the index parameter.
   A typical query service will attempt to use the first mechanism to get back all information modifiers related to the target subscriber and then fall back to using the secondary query mechanism, one modifier at a time until all modifiers had been retrieved, after discovering that the provided info-modifier array was too small. Special boolean modifiers and grouping are allowed to support multiple-rule-aggregation. Left and right parentheses (i.e. ‘(’ and ‘)’) can be used to group information modifiers and defined groupings can be nested within other groupings. Boolean “and” operators (i.e. ‘&&’) and Boolean “or” operators (i.e. ‘∥’) can be used to relate one information modifier to another or relate one information modifier to a grouping of modifiers or relate one grouping of modifiers to other groupings of modifiers. If the wireless user's “found” location is more accurate than allowed by the aggregated privacy evaluation determined by the privacy center 100 utilizing the wireless user's criteria stored in the fidelity database 105, then the accuracy of the location information must be reduced to the level previously specified by the wireless user 125.

The change in the accuracy of the location information may be performed in the privacy center itself, or within the location management system 160 as instructed by the privacy center 100. Accuracy may be reduced using any otherwise conventional suitable technique, e.g., as is performed by the Global Positioning Satellite (GPS) system in times of war. For instance, instead of providing location information to within a 10 foot accuracy, location information may be provided to within a much larger accuracy, e.g., to within 300 feet by randomly moving the location within the desired window of accuracy.

In this embodiment, preference analysis continues—observing parenthetical groupings as well as boolean “and” and “or” operators—until all applicable preferences have been aggregated into a single, preferential “end-result”.

While the invention has been described with reference to the exemplary embodiments thereof, those skilled in the art will be able to make various modifications to the described embodiments of the invention without departing from the true spirit and scope of the invention.

What is claimed is:

1. A method of adjusting current location information regarding a wireless device, comprising:
receiving a location request for current location information regarding a particular wireless device;
adjusting an accuracy of said current location information corresponding to said particular wireless device based on an aggregation of a plurality of location modifiers, each of said plurality of location modifiers adjusting said accuracy of said current location from a more accurate version to a less accurate version having reduced accuracy; and
transmitting, as a response to said location request, said less accurate current location information.

2. The method of adjusting current location information regarding a wireless device according to claim 1, wherein:
said plurality of location modifiers includes a spoofing of said current location.

3. The method of adjusting current location information regarding a wireless device according to claim 1, wherein:
said plurality of location modifiers are configurably defined on a device-by-device basis.

4. The method of adjusting current location information regarding a wireless device according to claim 1, wherein:
said plurality of location modifiers includes a time of day parameter for a given accuracy of location.
